(19) United States
(12) Patent Application Publication
(10) Pub. No.: US 2018/0127236 A1
(43) Pub. Date: May 10, 2018

(54) ELECTRICALLY AUTONOMOUS ELEVATOR SYSTEM

(71) Applicant: OTIS ELEVATOR COMPANY, Farmington, CT (US)

(72) Inventor: Zbigniew Piech, Cheshire, CT (US)

(21) Appl. No.: 15/345,192

(22) Filed: Nov. 7, 2016

(51) Int. Cl. B66B 5/02; B66B 11/04; B66B 9/00

(52) U.S. Cl. CPC B66B 5/021; B66B 11/0407; B66B 9/00; B66B 11/04; B66B 11/043

(57) ABSTRACT

An electrically autonomous elevator system includes an elevator car configured to move in a hoistway in a first direction of travel. The elevator car is connected to a counterweight assembly operating on a guide rail constructed and arranged to guide the counterweight along a hoistway in a second direction of travel. The counterweight includes a propulsion system configured to propel the counterweight and thereby the elevator car. The elevator also includes a power transfer system configured to transfer power to a power system on the counterweight, the power system configured to power the propulsion system independent of the power transfer system for at least a selected duration.

### BACKGROUND

The present disclosure relates to electromechanical propulsion systems, and more particularly to electrically autonomous elevator systems having counterweight based propulsion systems.

A typical elevator system includes a car and a counterweight disposed within a hoistway, a plurality of tension ropes that interconnect the car and counterweight, and a drive unit having a drive sheave engaged with the tension ropes to drive the car and the counterweight. The ropes, and thereby the car and counterweight, are driven by rotating the drive sheave. In some elevator systems, a propulsion system may be mounted on the counterweight. In some systems, linear motors are employed where the secondary part often equipped in magnetic poles, permanent magnets or ferromagnetic saliency, is mounted in the hoistway in the form of rail over which the motor primary will run.

Elevator cars typically need power for ventilation, lighting systems, operation of doors and brakes, control units, communication units and to recharge batteries installed, for example, on an elevator car controller. Moreover, elevator cars may require back-up systems in case of a power failure. Existing systems use moving cables or current collectors/sliders to connect a moving elevator car with power lines distributed along the elevator hoistway. These systems while simple and functional also require maintenance inspection and may be less reliable than desired.

There exist a need in the industry for an electrically autonomous elevator that alleviates certain problems relative to many elevator systems with machine rooms or incorporating propulsion systems at the counterweight and eliminates cumbersome travelling cables for power and communications.

### SUMMARY

According to an embodiment, disclosed herein is an electrically autonomous elevator system. The electrically autonomous elevator system includes an elevator car configured to move in a hoistway in a first direction of travel, a counterweight assembly operably connected to the elevator car and a guide rail constructed and arranged to guide the counterweight along a hoistway in a second direction of travel. The system also includes a propulsion system disposed at the counterweight; and a power transfer system configured to transfer power to a power system disposed at the counterweight, wherein the power system is configured to power at least the propulsion system independent of the power transfer system for at least a selected duration.

In addition to one or more of the features described above, or as an alternative, further embodiments may include either a rotary or linear motor as the electromechanical propulsion system. In addition the linear motor may include a moving primary portion and a fixed secondary portion, the fixed secondary portion incorporating at least portion of a guide rail.

Further to one or more of the features described above, or as another alternative, further embodiments may include that the power system includes at least one of a power source and a converter that receives energy from the power source and outputs at least one excitation current to the propulsion system. In addition the power system includes at least an energy storage device, and in addition, that the energy storage device includes at least one of a battery, a capacitor, and an ultracapacitor.

In addition to one or more of the features described above, or as an alternative, further embodiments may also include that the power system further includes a rectifier or converter configured to convert building or grid power to DC and supply it to at least one of the converter and energy storage device.

In addition to one or more of the features described above, or as an alternative, further embodiments may include that the power transfer system provides grid power to the power system, and further yet that the power transfer system is operable to provide DC power to the power system. Moreover the power transfer system may include a mating contact operable to provide DC power to the power system while the elevator car is at a selected location.

In addition to one or more of the features described above, or as an alternative, further embodiments may include that the selected duration is at least one minute or that the selected duration is at least one hour or that the selected duration is at least 8 hours.

In addition to one or more of the features described above, or as an alternative, further embodiments may include that the selected duration is determined based on the elevator system operational parameters or further that an operational parameters may include state of charge of the energy storage device.

In addition to one or more of the features described above, or as an alternative, further embodiments may further include a non-contacting communication system, or further yet that the non-contacting communication system is at least one of a wireless system and an inductive system.

In addition to one or more of the features described above, or as an alternative, further embodiments may include an elevator car subsystem, or where the elevator car subsystem includes at least one of a ventilation unit, a lighting system, door operation unit, brake unit, display unit, a control unit, and a communication unit.

According to an embodiment, disclosed herein is method of powering an electrically autonomous elevator system. The method includes operably connecting an elevator car configured to move in a hoistway in a first direction of travel with a counterweight assembly configured to travel on a guide rail constructed and arranged to guide the counterweight along a hoistway in a second direction of travel. The method also includes disposing a propulsion system configured to propel the counterweight in the second direction of travel at the counterweight and transferring power to a power system disposed at the counterweight, the power system configured to power at least the propulsion system independent of the power transfer system for at least a selected duration.

In addition to one or more of the features described above, or as an alternative, further embodiments may include that the transferring of power for at least a selected duration be at least one minute.

In addition to one or more of the features described above, or as an alternative, further embodiments may further include communicating with a non-contacting communication system from a moving portion of the elevator system to a fixed portion of the elevator system.

Technical effects of embodiments of the present disclosure include an autonomous elevator system and control system employing a counterweight based propulsion system and a power transfer system. The elevator system is operable to provide service independent of the power transfer system for a selected duration. Technical effects also include a power connection system and communication system for powering and communications with elevator car subsystems and to fixed parts of the system.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 depicts an elevator system of an exemplary embodiment;

FIG. 2 is a block diagram of the elevator system in accordance with an exemplary embodiment;

FIG. 3 is a partial side view of a counterweight assembly and propulsion system of an exemplary embodiment;

FIG. 4 is a perspective diagram depicting a portion of propulsion system of an exemplary embodiment;

FIG. 5 is a diagram of the elevator belts with communication system in accordance with an exemplary embodiment;

FIG. 6 is a diagram of a belt with communication cables in accordance with an exemplary embodiment; and

FIG. 7 depicts a sectional view of a communication system with pickups in accordance with an exemplary embodiment.

### DETAILED DESCRIPTION

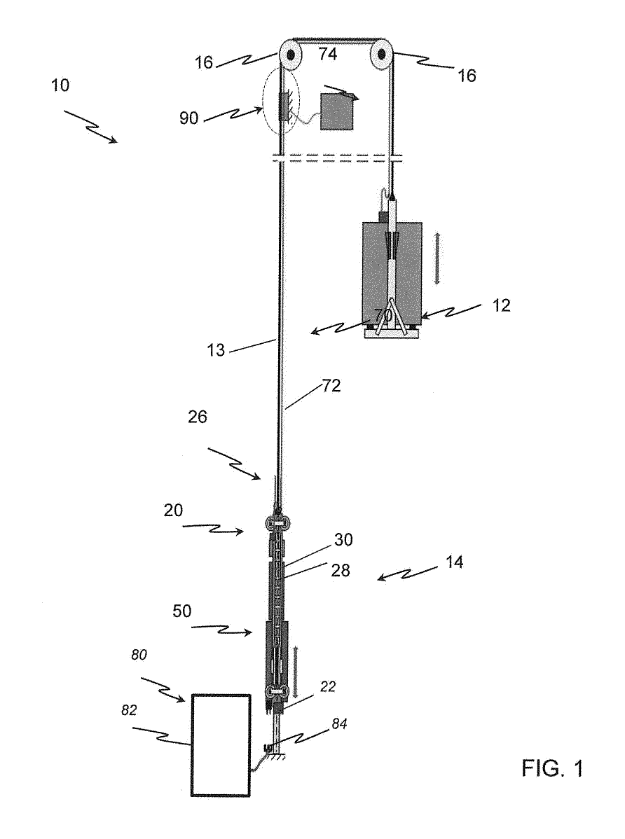

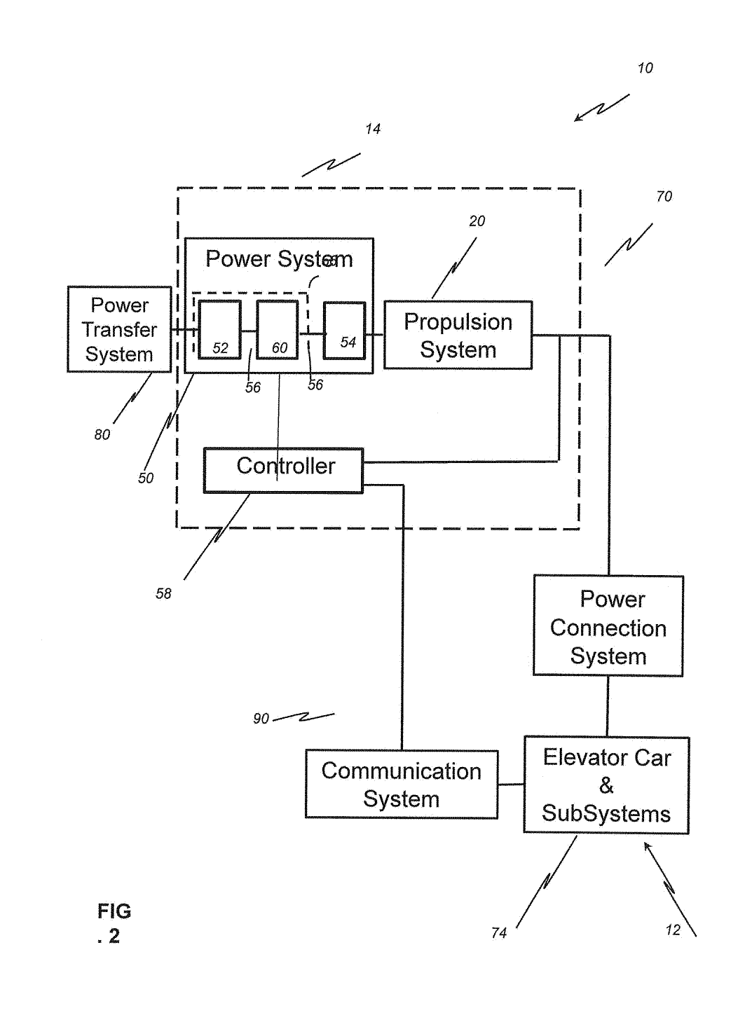

Referring now to FIGS. 1 and 2, there is shown schematically an exemplary embodiment of an elevator system 10 which derives its motive power from propulsion system 20 mounted at the counterweight assembly 14. In FIG. 1, the elevator car 12 operates in communication with guide rails mounted in a hoistway (not shown) for movement therein. The guide rails typically ensure proper alignment of the elevator car in the hoistway and also provide structure for mounting and operation of other components of the elevator system 10 for example, sensors, brakes, safety brakes. In an exemplary embodiment, the propulsion system 20 is a switched flux permanent magnet linear motor 26. The core or primary 30 is the moving portion of the linear motor 26 formed on of the counterweight assembly 14, and the secondary 28 is fixed and comprises at least a portion of the guide rail assembly 22. The secondary 28 being mounted on the guide rail(s) 22, or being integral part of the guide rail(s) 22, or being mounted separately from the guide rail(s) 22. While an embodiment has been described employing linear motor configuration as the propulsion system 20 it should be appreciated that other configurations for the propulsion system 20 are possible including a magnetic screw, rotary motors with sheaves or gears and the like. A pair of non-driven sheaves 16 is mounted in the top of the hoistway for engagement by a rope or belt 13 which is connected to the car 12 and the counterweight assembly 14. The counterweight assembly 14 moves along the guide rail assembly 22 mounted in the hoistway to facilitate movement of the counterweight assembly 14 and thereby the elevator car 12. In an embodiment, the guide rail assembly 22 or a portion thereof also serves as the secondary 28 for the linear motor 26 of the propulsion system 20. Moreover, in embodiment, the guide rail 22 is formed from an elongated flat strip of steel and is mounted in the hoistway by means of an U-beam or adjacent parallel T beams 24 secured to a hoistway wall (not shown). The aforesaid is simply a general description if the category of elevator assembly to which this invention pertains.

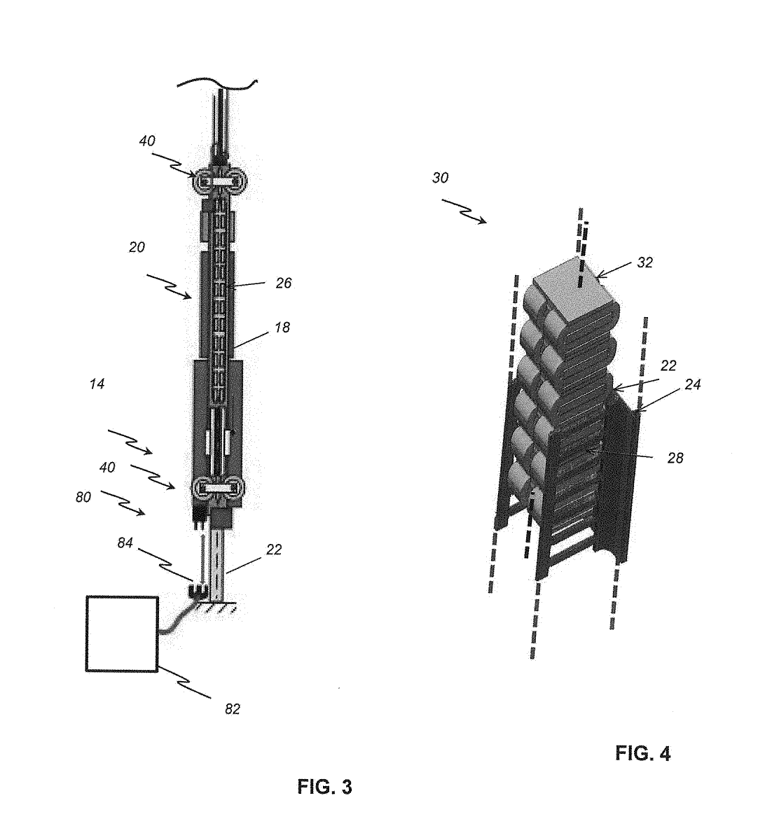

Continuing with FIGS. 1 and 2, and referring to FIGS. 3 and 4 as well, details of the counterweight assembly 14, and propulsion system 20 including the linear motor 26, and the guide 22 of an embodiment are shown. The counterweight assembly 14 has a frame 18 on which the various components of the propulsion system 20 are mounted. The primary 30 of the linear motor 26 is mounted on the frame 18 and is composed of a plurality of substantially flat windings 32. Primary 30 of the propulsion system 20 is supplied with drive excitations from a converter 54 (FIG. 1) to generate a magnetic flux that imparts a force on the secondary 28 to control movement of the counterweight assembly 14 (e.g., moving up, down, or holding still). It is contemplated and understood that any number of primary portions 30 may be mounted to the counterweight assembly 14, and any number of secondary portions 28 may be associated with the primary portions 30 in any number of configurations.

Also mounted on the counterweight assembly 14 and elevator car 12 are sets of guides 40 comprising rollers, slide guides and the like which engage the rails 22 to maintain proper spacing and travel of the counterweight assembly 14 and/or elevator car 12 in the hoistway. Further, in an embodiment, the guides on the counterweight assembly 14 are also operable to maintain a desired gap between the linear motor windings 32 of the primary 30 and the rails 22 of secondary 28. Maintaining the desired gap in the linear motor ensures desired operability as is known in the art. Advantageously with the placement of the propulsion system 20 on the counterweight assembly 14, facilitates independent selection of guidance tolerances for the counterweight assembly 14 and elevator car 12. In an embodiment, this permits maintenance of tight tolerances, e.g., up to about 1.5 millimeters, as required for desirable performance of the linear motor 40 on the counterweight assembly, while more compliant standard guidance and tolerances are employed for the elevator car 12 in the hoistway to ensure desirable ride comfort for passengers. In one embodiment any desired tolerances, including those greater than or less than 1.5 millimeters may be used.

Referring again to FIGS. 1 and 2, in an exemplary embodiment, the elevator system 10 and counterweight may include power system 50. The power system 50 may include, but not be limited to a power source 52, one or more power converters 54 or propulsion drives, buses 56 and one or more controllers 58. The power sources 52 are electrically coupled to the power converters 54 via the buses 56. In one non-limiting example, the power sources 52 may be direct current (DC) power sources. DC power sources 52 may be implemented using energy storage devices 60 (e.g., batteries, capacitors, ultracapacitors and the like), and may include active devices that condition power from another source (e.g., rectifiers connected to power grid, generators, etc.). In another embodiment the power source 52 may be a rectifier or converter for converting incoming or grid power to DC for charging the energy storage devices 60 and or supplying power to the power converters 54. In an embodiment of the elevator system 10, the counterweight assembly includes one or more storage devices or batteries 60 for providing power to the propulsion system 20. The power converters 54 may receive DC or AC power from the buses 56 depending on the desired implementation of the power system 50, and provide drive excitations to the primary portions 30 of the linear motor 26 for propulsion system 20. Each power converter 54 may be a converter that converts DC or AC power from bus 56 to a multiphase drive excitation provided to a respective winding 32 portions of the primary 30. The primary portion 30 may be divided into a plurality of modules or sections, with each section associated with a respective power converter 54.

The controller 58 provides control signals to the power converter(s) 54 to control generation of the drive excitation for the propulsion system 20. Controller 58 may use pulse width modulation (PWM) control signals to control generation of the drive excitations by the power converters 54. Controller 58 may be implemented using a signal processor-based device programmed to generate the control signals. The controller 58 may be distributed as a part of each converter 54 to generate control signal for corresponding converter. The controller 58 may also be part of an elevator control system or elevator management system used to control the dispatching of the elevator car to a desired floor in the building. Elements of the power system 50 may be implemented in a single, integrated module, and/or be distributed along the hoistway as required.

Continuing with FIGS. 1 and 2, a power connection system 70 of the elevator system 10 may be used to provide power to loads or elevator car subsystems 74 on the elevator car 12. The power connection system 70 may be an integral part of the power system 50 thereby sharing various components such as the controller 58, buses 56, power source 52, power converters 54, and other components. In an exemplary embodiment, the power connection system 70 may include a power transfer cable 72 configured to carry power to the elevator car load and subsystems shown generally as 74. The subsystems 74 may include, but not be limited to, a ventilation and/or cooling unit, a lighting system, a door operation unit, brake unit, display unit, a control unit, a communication unit, batteries or energy storage devices, and others. The subsystems 74 may be alternating current (AC) loads, such as fans of the ventilation unit and others, utilizing a traditional power frequency such as, for example, about 60 Hz. Alternatively, or in addition thereto, the subsystems may include direct current (DC) loads, such as a display unit.

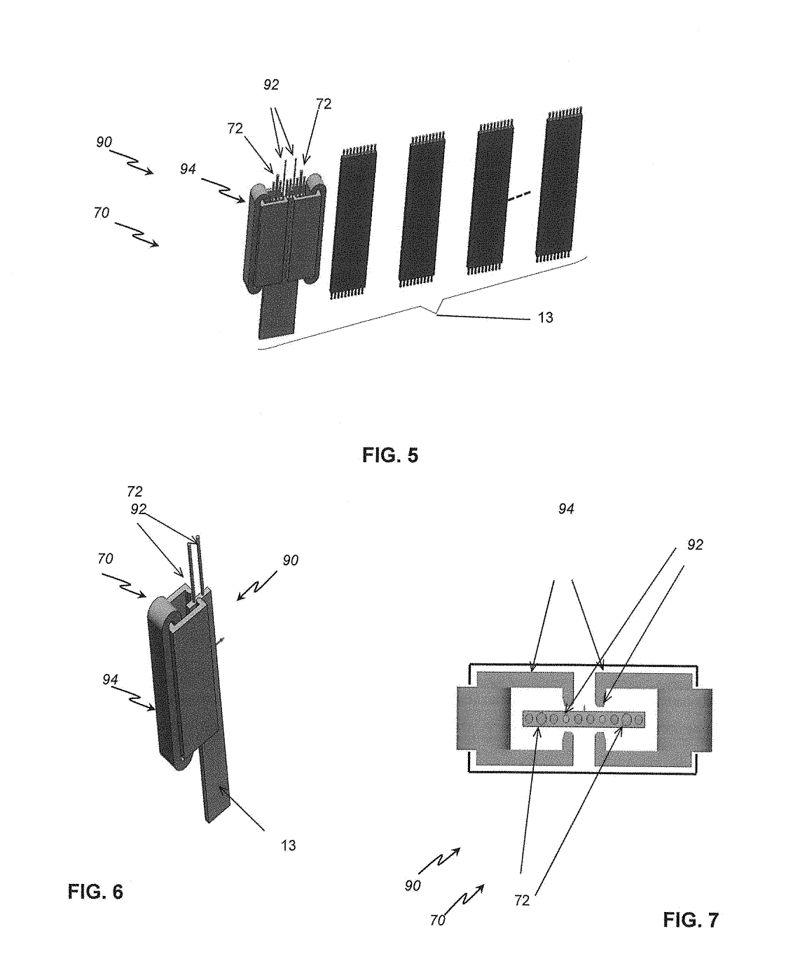

Turning now to FIGS. 5, 6, and 7, an example of a power connection system 70 is depicted. In an embodiment in a simple form, the power connection system 70 includes two wires 72 routed parallel to or integral with the elevator ropes or belts 13 to carry power from the power source 52 and/or storage devices 60 to the subsystems 74 of elevator car 12. FIG. 5 depicts, an example cutaway section of five belts (though more or less may be employed) with a belt 13 including a set of wires 72. In addition, FIG. 5 depicts the belt 13 including two additional conductors as signal communication cables 92 for communications with pickup coils placed in proximity to the signal communication cables 92 to facilitate contactless inductive coupling for communication as will be described further herein. FIG. 7 depicts a cut away view of a belt 13 with power transfer cable 72. It also depicts the signal cables 92 and pick up coils 94. It should be appreciated that the power transfer cable 72 could be separate or integral with the ropes or belts 13 or even cords in the belt employed to propel the elevator car 12.

The elevator system 10 of an embodiment may also include a non-contacting communication system 90 to facilitate communication between the moving system of the counterweight 14 and elevator car 12 and subsystems 74. In one embodiment the communication may be any form of industry standard wireless communications employing typical antenna such as cellular, WiFi®, Bluetooth®, Zigbee®, Zwave®, and the like. While there are many advantages to employing an industry standard wireless communications, other approaches are also advantageous for the elevator industry. For ease of installation, configuration and to minimize any potential for external attack or eavesdropping, a simple inductive system for communication would be advantageous.

In an exemplary embodiment, a wireless, non-contacting communication system 90 employing inductive or magnetic coupling is employed. FIGS. 5, 6, and 7, depict a wireless communication system 90 in accordance with an embodiment. In an embodiment, as depicted in FIGS. 5 and 7, a belt 13 includes two (or more) conductors 72 to carry DC power from the batteries 60 to the elevator car 12 as described above. In addition, the belt 13 may include two conductors as signal communication cables 92 for communications. In FIGS. 5, and 7, in an embodiment, signals communicated along communication cables 92 inductively/magnetically couple energy to and from a pickup coil 94 to the non-moving parts for the elevator for command, control, and diagnostic purposes. In another embodiment, as depicted in FIG. 6 communications cables 92 are one in the same with the power connection cables 72 and communications signals are integrated, multiplexed, or modulated onto the power connection cables 72 using well know power line communication techniques. It will be appreciated that while a simple two wire inductive communication system is described, many other configurations for the communication system are possible. Multiple systems or redundant systems may be employed to improve bandwidth, communication integrity, and the like. Likewise, simpler systems may be employed with ropes a cables sharing being dedicated for the power connection system 70 or communication system 90. Moreover completely independent systems where one belt 13 is just for communication or power connection are also envisioned.

Referring back to FIGS. 1 and 2, in an embodiment, a power transfer system 80 of the elevator system 10 may be used to deliver power from the fixed portion (for example the hoistway, building, and ultimately the grid) to the moving portion of the elevator system 10. In an exemplary embodiment the power transfer system 80 couples power to the power system 50 of the counterweight assembly 14 either continuously, or at intervals for a selected duration. The power transfer system 80 can include a physical connection e.g., fixed mating contacts, connector and the like, or be completely non-contacting, e.g., inductive power coupling. The controller 58 may monitor elevator system operational parameters, including, but no limited to state of charge, charge or discharge rate, battery health, and system usage, and/or trends and functions of the same to determine the durations for charging. Under selected conditions, the elevator system could require brief durations of charging. In another embodiment, under selected conditions, the elevator system 10 could modify its performance or temporarily take itself out of service if state of charge, storage levels, or discharge rates are not sufficient for proper operation and therefore longer durations to satisfy charging requirements.

In one embodiment, the power transfer system 80 is a battery charger 82 configured to recharge the storage devices or batteries 60 of the power system 50. The battery charger 82 can be any kind of power supply device configured to recharge the storage devices or batteries 60. The battery charger 82 may be configured with the capacity and current capability to rapidly charge the storages devices or batteries 60 as needed, and however the battery charger 82 may be configured to trickle charge the storage devices 60 as needed to maintain charge and prevent overheating. The storage devices or batteries 60 of the power system 50 may be sized and of sufficient capacity to ensure for autonomous operation of elevator system for a desired duration. It should be appreciated that the autonomous operation mode depends on type and capacity of energy storage device (battery) 60 applied in the elevator system 10. Energy storage devices 60 with large capacities facilitate longer autonomous operation of elevator system 10. For example, daily operation with recharging overnight. In one embodiment, the autonomous operation may be short, just sufficient to maintain elevator system operation during a brief power outage. This would be highly advantageous when operating in locations where the power grid is not always reliable. In another embodiment, the autonomous operation may extend the complete daily cycle with only intermittent short duration recharge cycles for energy storage devices 60. In yet another embodiment, the autonomous operation duration could be much longer. Of course when usage is particularly heavy (e.g. arrival, departure, lunch time) the energy storage devices may experience a cumulative state of charge loss for about 1-2 hours. Under such conditions, it may be required to stop at a landing with a battery charger 82 for a longer duration to maintain or restore the charge on the energy storage devices 60. Furthermore, there may also be instance with short duration charging intervals e.g., on the order of tens of seconds, for example in one embodiment, 20 seconds, a minute, to a few minutes would be sufficient to maintain satisfactory charge. In some instances, for example, under heavier use, the duration of minimum time of charging may be at least an hour. In yet another embodiment the energy storage devices 60 are configured and of sufficient capacity to power the elevator system 10 substantially continuously, recharging only when the elevator system is idle at a selected landing or landings. The power system 50 may include power monitoring and diagnostics for the power system 50, particularly, the energy storage devices 60.

The power transfer system 80 may be alternating current (AC) or direct current (DC) In an embodiment the power transfer system is a AC system, for example, about 60 Hz and includes a rectifier or converter operable configured to charge the storage devices 60. Alternatively, or in addition thereto, the may include direct current (DC). The power transfer system 80 may be a portion or integral part of the power system 50 thereby sharing various components such as the controller 58 (see FIG. 3), buses 56, and the like and operably connected therewith. In an exemplary embodiment, the power transfer system includes a set of mating contacts 84 or connection configured to engage with the counterweight assembly when the elevator car 12 is a at one or more landings, for example, lobby floor, thereby recharging the batteries 60 at for a selected duration at selected intervals. In another embodiment, the power transfer system 80 can be a wireless inductive power transfer system as is well understood in the art.

Advantageously, employing batteries 60 as part of the counterweight assembly 14 may provide for a portion or all of the mass/weight required to for the counterweight to achieve desirable performance of the elevator system 10. The uniqueness of the elevator system with energy storage device 60 mounted in the counterweight 14 permits application of very large storage capacities despite their weight. For desirable performance and efficient operation, the counterweight 14 in an elevator system 10 is typically required to be equivalent to the weight of car 12, ropes 13 and about 50% of the weight of a passenger load. Therefore embodiments with applications of energy storage device(s) 60 (batteries) weighing on the order of a few tons are feasible. In addition, to further extend durations of autonomous operation of the elevator system 10 the energy storage devices 60 may be periodically recharged from the propulsion system 20 during the regenerative run of the elevator system independent of access to external power grid. In a regenerative operation, gravity is employed to propel the elevator car, for example, elevator car ascending under light car 12 or heavy counterweight 14 conditions and the propulsion system 50 is employed in a generator mode to provide braking force and thereby controlling the descent of the counterweight 14 and recharging the energy storage devices 60. Moreover it will be appreciated that the energy storage devices 60 placed at the counterweight 14 may also permit additional system uses for other needs of the building when counterweight is parked on the floor with connection to the building grid. For example providing power to other electrical systems, emergency systems, lighting, garaged doors systems, security systems, and the like. The energy storage devices could be sized to provide energy storage capability for the building. For example energy storage from a renewable source for use by the building as needed. Once again, it should be understood that the interval of operation, duration, and recharging interval may all be configured as desired.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1. An electrically autonomous elevator system comprising:
an elevator car configured to move in a hoistway in a first direction of travel;
a counterweight assembly operably connected to the elevator car;
a guide rail constructed and arranged to guide the counterweight along a hoistway in a second direction of travel;
a propulsion system disposed at the counterweight; and
a power transfer system configured to transfer power to a power system disposed at the counterweight, wherein the power system is configured to power at least the propulsion system independent of the power transfer system for at least a selected duration.

2. The elevator system set forth in claim 1, wherein the electromechanical propulsion system is a linear motor.

3. The elevator system set forth in claim 2, wherein the linear motor comprises a moving primary portion and a fixed secondary portion, the fixed secondary portion incorporating at least portion of a guide rail.

4. The elevator system set forth in claim 1, wherein the electromechanical propulsion system is a rotating electromechanical motor.

5. The elevator system of claim 4, wherein the propulsion system incorporates at least a portion of the guide rail.

6. The elevator system set forth in claim 1, wherein the power system includes at least one of a power source and a converter that receives energy from the power source and outputs at least one excitation current to the propulsion system.

7. The elevator system set forth in claim 6, wherein the power system includes at least an energy storage device.

8. The elevator system set forth in claim 7, wherein the energy storage device includes at least one of a battery, a capacitor, and an ultracapacitor.

9. The elevator system set forth in claim 6, wherein the power system further includes a rectifier or converter configured to convert building or grid power to DC and supply it to at least one of the converter and energy storage device.

10. The elevator system set forth in claim 1, wherein the power transfer system is operable to provide at least one of DC power or grid power to the power system.

11. The elevator system set forth in claim 1, wherein the power transfer system include a mating contact operable to provide DC power to the power system while the elevator car is at a selected location.

12. The elevator system set forth in claim 1 wherein the selected duration is at least twenty seconds.

13. The elevator system set forth in claim 12 wherein the selected duration is at least one minute.

14. The elevator system set forth in claim 1 wherein the selected duration is determined based on the elevator system operational parameters.

15. The elevator system set forth in claim 14 wherein the elevator system operational parameters include state of charge of the energy storage device.

16. The elevator system set forth in claim 1 further comprising a non-contacting communication system.

17. The elevator system set forth in claim 16 wherein the non-contacting communication system is at least one of a wireless system and an inductive system.

18. A method of powering an electrically autonomous elevator system comprising:
operably connecting an elevator car configured to move in a hoistway in a first direction of travel with a counterweight assembly configured to travel on a guide rail constructed and arranged to guide the counterweight along a hoistway in a second direction of travel;
disposing a propulsion system configured to propel the counterweight in the second direction of travel at the counterweight; and
transferring power to a power system disposed at the counterweight, the power system configured to power at least the propulsion system independent of the power transfer system for at least a selected duration.

19. The method of powering an electrically autonomous elevator system set forth in claim 18 wherein the selected duration is at least one of at least twenty seconds, one minute, and one hour.

20. The method of powering an electrically autonomous elevator system set forth in claim 18 further comprising communicating with a non-contacting communication system from a moving portion of the elevator system to a fixed portion of the elevator system.
